(19) United States
(12) Patent Application Publication
(10) Pub. No.: US 2018/0086558 A1
(43) Pub. Date: Mar. 29, 2018

(54) AUTOMATIC STORAGE FACILITY VEHICLES AND METHOD OF PROVIDING POWER

(71) Applicant: Logevo AB, ALMHULT (SE)

(72) Inventor: Rickard BERGENDORFF, Tving (SE)

(21) Appl. No.: 15/566,501

(22) PCT Filed: Apr. 13, 2016
(86) PCT No.: PCT/SE2016/050322

§ 371 Date: Oct. 13, 2017

(30) Foreign Application Priority Data
Apr. 14, 2015 (SE) 1550448-3

(51) Int. Cl. B65G 1/04; B60L 11/18; B60L 5/38; H02J 7/00

(52) U.S. Cl. CPC B65G 1/0414; B60L 11/1816; B60L 5/38; H02J 7/345; B60L 11/1866; H02J 7/0021; H02J 7/0014; B60L 11/1861

(57) ABSTRACT

A set of transport vehicles for an automatic storage facility having a transfer cart having wheels and being capable of running on rails, and capable of carrying a shuttle, the shuttle having wheels and being capable of leaving the transfer cart and being capable of collecting, carrying, and leaving goods stored in a storage aisle wherein the shuttle includes:
at least one shuttle electric motor,
a first capacitor bank to provide energy to power the at least one shuttle electric motor, and
a first connector organ to electrically connect the shuttle to the transfer cart and in that the transfer cart comprises includes:
at least one transfer cart electric motor,
a second connector organ to electrically connect the shuttle to the transfer cart,
a second bank of capacitors to provide energy to charge the shuttle first bank of capacitors, via the connector organs, when the shuttle is carried by, and connected to the transfer cart.

### TECHNICAL FIELD

The present invention relates to power systems for electric vehicles of goods storage systems, and to such vehicles. More particularly it relates to shuttles and transfer carts for single or multi-storey goods storage arrangements that may comprise a plurality of levels of storage aisles and one or more transport aisles, perpendicular to the storage aisles, and the first ends of one or more groups of storage aisles located adjacent to a transport aisle.

### PRIOR ART

Single or multi-storey goods storage arrangements or pallet racks are used in a wide area of applications, such as conventional warehouses, storages and stores. Goods, such as packages or cases, are normally arranged on pallets or base boards that are transported in the multi-storey goods storage arrangement by different kinds of carts, carriages, shuttles and/or conveyors. In automated multi-storey goods storage arrangements the carriages, shuttles, and conveyors are controlled by a computer system and pick up, transport, store and deliver goods without human influence.

The automated carts, carriages and/or shuttles are often powered from internal batteries, or powered from a conductor rail system, the rails of which typically run parallel to a transport rail system on which the wheeled carts, carriages, and shuttles roll.

### SUMMARY OF THE INVENTION

It has been identified that batteries have drawbacks such as high weight, environmental hazard, difficulties of transport, in particular when the batteries need to be transported by air. They also have to be charged at regular or non-regular intervals. During a charging period, the transport vehicle (cart/carriage/shuttle) may be unable to perform its regular tasks. It would be desirable to improve the concept of prior art multi-storey goods storage arrangements in the field of powering such automated carts/carriages/shuttles. Advantages of the present invention include an increased life cycle length compared to a solution based on batteries. Batteries are able to manage a certain number of charging and discharging cycles and capacitors can manage many more.

The multi-storey goods storage arrangement comprises a plurality of levels of storage aisles arranged in parallel and transport aisles or aisles extending between opposing ends of said storage aisles. In such a storage system, at least one pallet or baseboard transfer cart is operable along each transport aisle to carry a shuttle carrying pallets or baseboards supporting goods. The shuttle is arranged to be able to leave the transfer cart and propel itself to selected positions in said storage aisles, where it can leave or pick up goods.

The invention concerns an improved power system of said transfer cart and shuttle by providing each shuttle with a high energy capacitor bank, which is significantly lighter than a corresponding battery pack. There is also provided for fast recharging of the capacitor bank, reducing any recovery time due to charging. Further there is provided a monitoring system that monitors the voltage of each capacitor in the capacitor bank. There is also provided, preferably as part of the monitoring system, an over voltage handling system, that dissipate an over voltage of each capacitor into heat.

In various embodiments said pallet or baseboard transfer cart is powered from a conductor rail system, the rails of which run in parallel with the transport rails on which the transfer cart wheels. The transfer cart is provided with a charging station for the shuttle. The charging station is powered with electricity picked up from the conductor rails. There are means arranged to make contact and pick up energy from the conductor rails, e.g. using a trolley brush or the like.

When in operation, to fetch a piece of goods, the transfer cart, carrying an empty shuttle, is driven along the transport aisle to the appropriate front end of a storage aisle. Subsequently the shuttle is driven, using energy stored in its capacitor bank, into the storage aisle, to pick up the goods. When the goods are picked up the shuttle is driven back to the transfer cart. When the shuttle is parked on the transfer cart, the shuttle is recharged if necessary. The system allows fast recharging times, in the neighbourhood of only a few seconds, because energy is transferred from a capacitor bank of the transfer cart to the capacitor bank of the shuttle.

Thus, the transfer cart is driven to a destination storage aisle while, simultaneously, the carried shuttle is being recharged. The system is preferably configured such that the capacitor bank of the transfer cart can accept charging from a charger also when discharged to the shuttle capacitor bank. When the transfer cart has reached the front end of the destination storage aisle, the shuttle is released and driven to the appropriate position in the storage aisle using energy from its (the shuttle's) internal capacitor bank. Simultaneously with that, the capacitor bank of the transfer chart is recharged using electrical energy from conductor rails running in parallel with the rails on which the transfer cart is running. The voltage of the conductor rails is preferably arranged to be higher than the charging voltage of the capacitor bank of the transfer chart. The charging voltage of the shuttle capacitor bank is arranged to be lower than the working voltage of the capacitor bank of the transfer cart in order to facilitate quick charging of the capacitor bank of the shuttle from the capacitor bank of the transfer cart.

Thus, each time the shuttle returns to the transfer cart, the shuttle is electrically connected or “docked” to the transfer cart, and automatic charging takes place. The detailed design of such a connecting mechanism or such docking mechanism is not within the purpose of this document. For the purpose of this document it is enough to view such a mechanism or connector organs as a sliding contact or plug and socket connector that will use the position and/or travelling force of the shuttle to establish the connection.

### BRIEF DESCRIPTION OF THE DRAWINGS

In order that the manner in which the above recited and other advantages and objects of the invention are obtained will be readily understood, a more particular description of the invention briefly described above will be rendered by reference to specific embodiments thereof which are illustrated in the appended drawings.

Understanding that these drawings depict only typical embodiments of the invention and are not therefore to be considered to be limiting of its scope, the invention will be described and explained with additional specificity and detail through the use of the accompanying drawings in which:

FIG. 1a is a block diagram showing main electrical units of a transfer cart and a shuttle of a goods storage arrangement

FIG. 1b is a schematic view from above of a goods storage system comprising transport aisles, storage aisles, transport cart and shuttle

FIG. 1c is a perspective view of a shuttle for the storage system of FIG. 1b

FIG. 1d is a side view of a multi storey storage system with transfer cart and shuttle

FIG. 2 is a schematic connection diagram of capacitor bank with monitoring system

FIG. 2a is a diagram showing charging, discharging, and recharging of capacitors in a charge level vs time diagram for a shuttle capacitor bank. Charging events are market in the diagram.

FIG. 2b is a diagram showing a charge curve with charging, discharging, and recharging events for a capacitor bank of the charging station of the transfers chart when cooperating with the shuttle capacitor bank of FIG. 2a

FIG. 3 is a schematic diagram illustrating a balancing function of a balancing unit for balancing the charge level of individual capacitors of a capacitor bank of a shuttle or a transfer cart of FIG. 1.

### DETAILED DESCRIPTION

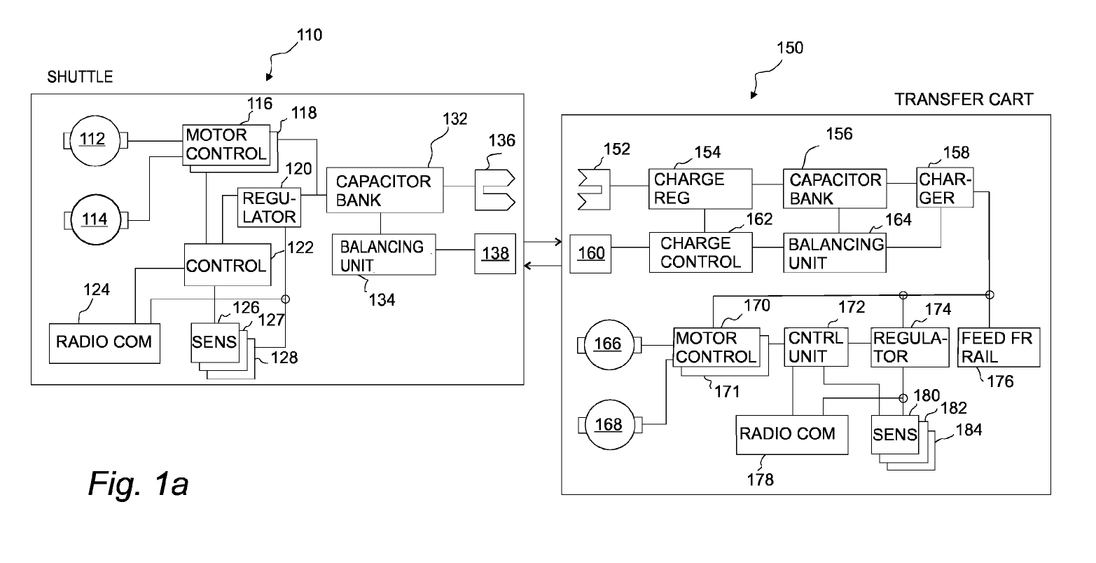

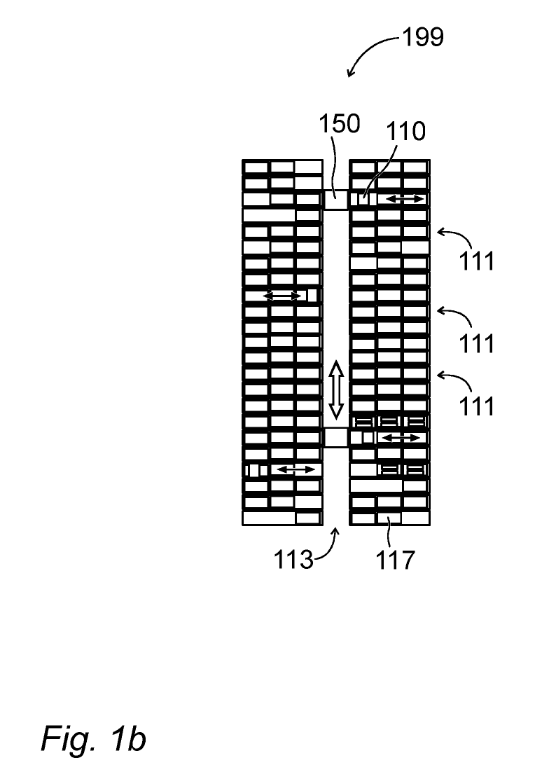

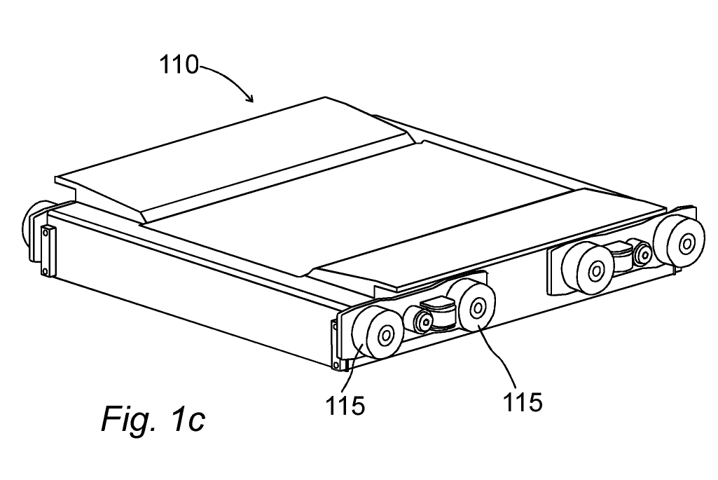

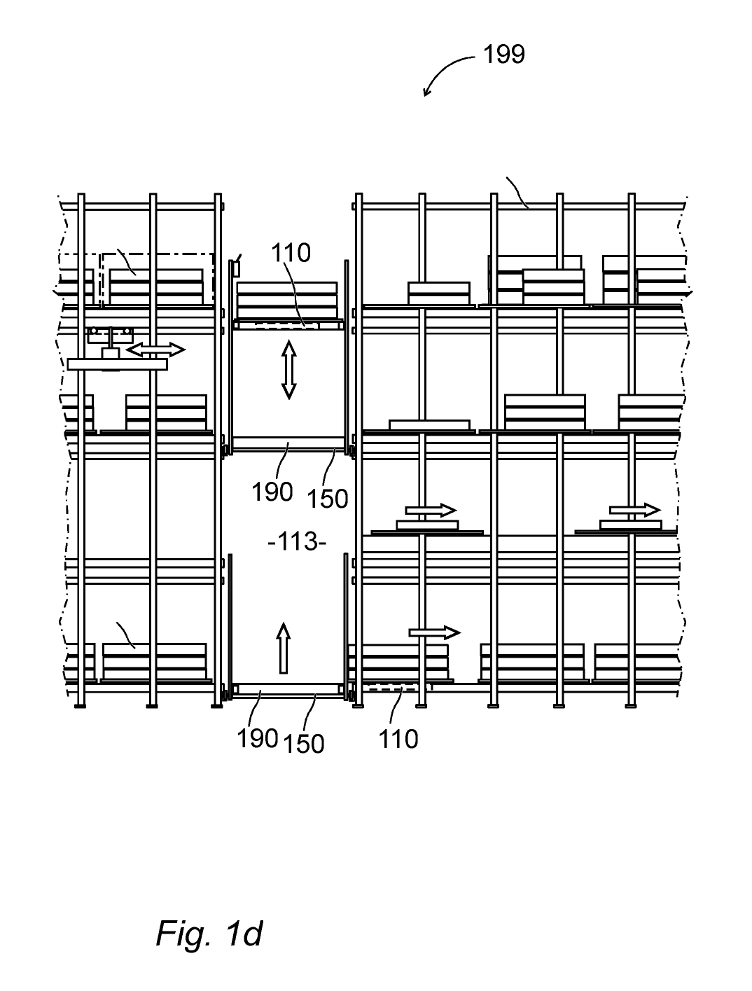

FIG. 1a shows a block diagram of main electrical units of a power system for a transfer cart 150 and a shuttle 110 for use in a goods storage arrangement comprising a plurality of storage aisles 111 arranged in parallel and having one or more transport aisles 113, perpendicular to, and running along consecutive first ends of a first group of storage aisles 111 on one side of the transport aisle 113, and optionally having a second group of storage aisles 111 on the other side of the transport aisle 113.

The intention of the power system is among other things to provide a lightweight propulsion system for these two vehicles, and avoiding the use of heavy and possibly hazardous batteries. The system comprises a first capacitor bank 132 arranged in the shuttle 110 and a second capacitor bank 156 arranged in the transfer cart 150. The relation of the transfer cart 150 to the shuttle 110 is that the transfer cart 150 is arranged to carry the shuttle with or without goods on rails of the transport aisle 113. The shuttle is arranged to be able to leave the transfer cart and travel on rails of the storage aisles 111 and to lift up at one location in a storage aisle, transport, and leave the goods on another position of the same storage aisle 111, or, which is more frequent, to leave it at a certain position of another storage aisle 111. No electrical rails, or electrical wires need to be provided for the shuttle, since no permanent connection between the shuttle and the transfer cart is needed.

The shuttle 110 is provided with an electric propulsion motor 112, and with a capacitor bank 132 arranged to be capable of holding a certain amount of energy for the propulsion motor 112 and for one or more lifting motor(s) 114 of the shuttle. The energy being arranged to be equal or in excess of what is needed in a worst case scenario of a transport cycle of the following:
the shuttle 110 leaving the transfer cart 150 into a storage aisle 111;
the shuttle 110 travelling to a distant position of the storage aisle 111;
lifting and carrying goods;
returning with the goods to the transfer cart 150.

During such a cycle the energy stored in the capacitor bank 132 will diminish over time as the motors 112, 114 are used.

As mentioned, in a storage facility 199, see FIGS. 1b and 1d, suitable to make use of the transport vehicles with the inventive power system, storage aisles 111 extend in two opposite directions from a transport aisle extending between opposite ends of said storage aisles 111, said transport aisle 113 also having a plurality of levels or stories. On each level of the transport aisle at least one transfer cart 150 supporting a shuttle 110, see e.g. FIG. 1c, operates in a direction perpendicular to the storage aisles. The transfer cart(s) 150 run on rails. The shuttle 110 is preferably supported in a conventional way on a rail system in a lower section of the transfer cart 150. A corresponding rail system extends along said storage aisles to allow said shuttle 110 to transport pallets to and from selected positions along said storage aisles 111.

Each shuttle 110 is arranged to move away from the transfer cart 150 into said storage aisles 111 carrying goods. The goods pallets can be transported along a storage aisle 111 to be placed at a selected position in the storage aisle 111. The pallets also can be picked up at a selected position by the shuttle 110 and transported to the transfer cart 150 which then will transport the picked up pallet along the transport aisle 113 to a selected new storage aisle 111.

Now referring to FIG. 1d, the multi-storey goods storage arrangement mentioned herein may basically be a pallet racking with a plurality of uprights and horizontal load beams. The load beams are arranged as or include the rail system for supporting the shuttle 110. Conventional diagonal braces and horizontal braces can also be used. As an additional feature the transport cart 150 is provided with a lifting gear 190 for elevating the transfer cart one storey.

The shuttle 110 is thus arranged to move from the transfer cart 150 into the storage aisles 111 and back carrying pallets with or without goods. The shuttle 110 is provided with support means that can be raised in position under a pallet and kept in a raised position during transport in the storage aisle. When goods have reached an intended position in the storage aisle 111 or elsewhere the support means is lowered and the goods will rest on rails or load beams or on the transfer cart 150.

In an alternate or supporting embodiment some of the transfer cart(s) are arranged to transport so called top shuttles, i.e., shuttles that are arranged to travel on rails above the pallets, and to pick up from a position above the goods, and deliver portions or packages being part of the total amount of goods on a pallet to another pallet.

### Capacitor Banks

As mentioned above the system comprises a first capacitor bank 132 arranged in the shuttle 110 and a second capacitor bank 156 arranged in the transfer cart 150. Now referring to FIG. 1a, the second capacitor bank 156 may be arranged as part of a charging station of the transfer cart 156. The second capacitor bank 156 is charged from a charger which is connected to a feed unit 176 picking up energy from electrical feed rails of the transport aisle via a sliding contact.

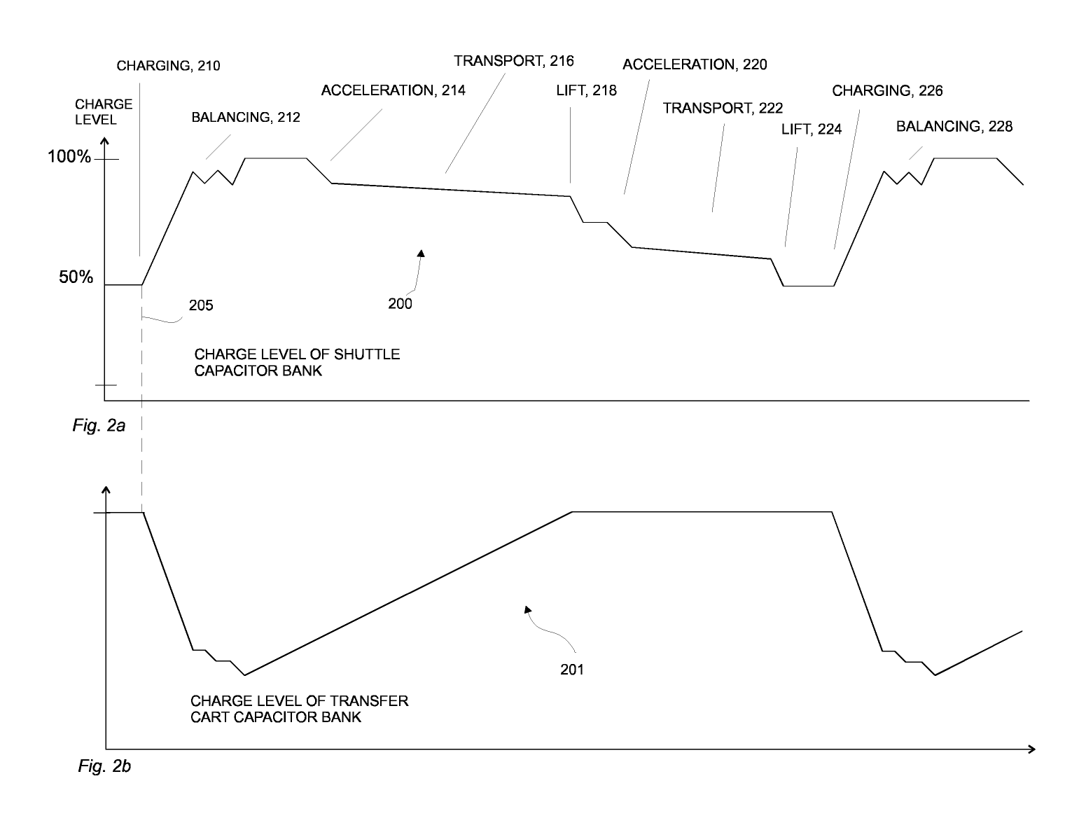

The first capacitor bank 132 is arranged as part of the shuttle 110. The first capacitor bank 132 is connected to a charging connector 136 which is arranged to mate with a corresponding charging connector 152 of the transfer cart 150 when the shuttle 110 is carried by the transfer cart 150. During the period when the two charging connectors 136, 152 are connected, the system is arranged to charge the first capacitor bank 132 by controlling energy flow from the second capacitor bank 156 to the first capacitor bank via a charge regulator 154 connected to a charge control unit 162 for controlling the charge regulator 154. Such a charge process has, among other things, the advantage over a process based on batteries as energy stores, as being much quicker. In the case of the present invention, so quick as to allow a full or almost full recharge of the first capacitor bank 132 from the second capacitor bank 156 during the time it takes for the transfer cart 150, when carrying the shuttle 110, to travel along the transport aisle from the front end of a first storage aisle to the front end of a second storage aisle 111. This would be further discussed with the aid of FIG. 2a and b. see below.

The first capacitor bank 132 is connected to a propulsion motor 112 of the shuttle 110 via a motor control unit 116 which receives control signals from a control unit 122 which in turn receives information from a radio communications unit 124 concerning information on where to pick up and deliver the next item(s) of goods origination from a central computer unit (not shown) of the storage facility. Information may also be sent in the opposite direction informing the central computer on the position and status of the shuttle 110. The control unit 122 is also preferably connected to a number of sensors to sense information on position and speed of the shuttle relative to the storage system, and also to sense position of the goods relatively to a reference point fixed on the shuttle.

The lift motor 114 is preferably arranged to power a lifts gear that lifts the goods from below. Depending on the demands of the storage system, the shuttle may also be provided with a further lift motor (not shown) that may be powered from the capacitor bank or from a battery. Such a further lift motor is preferably arranged to power lifting gear to lift goods from above, i.e. from a pallet on a level below the shuttle.

The transfer cart is provided with its propulsion motor 166 and a lift motor 168 arranged to lift the shuttle. The propulsion motor 166 being controlled by a control unit 172 of the transfer cart 150, which in turn is connected to and communicates with a radio communications unit 178 of the transfer cart 150. The control unit 172 is also connected to a regulator 174 that regulates the voltage of the current picked up from the sliding contact 176. The regulator is also connected to a number of sensors 180, 182, 184 for sensing the position and current status of the transfer cart, and for sensing the presence and position of the shuttle on the transfer cart.

Now referring to FIGS. 2a and 2b, a typical scenario of a goods transport cycle is shown with respect to the charge level of the first and second capacitor banks 132, 156. To the leftmost of FIG. 2a the shuttle capacitor bank 132 is at a charge level of about 50% and, see FIG. 2b, the transfer cart capacitor bank 156 is at a charge level of 100%. The shuttle is located at the transfer cart 150 and connected via connectors 136, 152. At a first point 210 in time, the transfer cart capacitor bank 156 starts charging the shuttle capacitor bank 132. Now the charge level of the shuttle capacitor bank 132 begins to increase while the charge level of the transfer cart 150 capacitor bank decreases. At a second point 212 in time, the shuttle capacitor bank is almost fully charged and a balancing process begins with the aid of a balancing unit 134. The balancing unit 134 and balancing process will be further described below.

Subsequent to the balancing process, the shuttle capacitor bank is fully charged, and the transfer cart capacitor bank has been correspondingly discharged, and can begin to recharge. At a third point 214 in time the shuttle is ordered out and accelerates 214 and travels 216 to a certain position in a storage aisle, this drains corresponding energy from the shuttle capacitor bank. Simultaneously, at the transfer cart, the second capacitor bank 156 continue to recharge with the aid of charger 158 and energy provided from feeding rails via sliding contact 176.

At fourth point 218 in time the shuttle has reached the intended position and starts lifting the goods. This drains further energy from first capacitor bank 132. At a fifth point 220 in time shuttle accelerates to travel to another position. At time period 222 the shuttle travels to said another position and subsequently, at a further point 224 in time lifts and releases goods. Simultaneously the transfer cart capacitor bank has been fully recharged.

At still a further point 226 in time the shuttle has returned to the transfer cart and charging and balancing 228 begins afresh.

Please note that a certain advantage is that the second capacitor bank 156 can be charged using a relatively low current during a relatively long time period.

### Capacitors and Balancing

The capacitor banks 132, 156 of the power system are provided with balancing units 134 and 164 respectively. These balancing units 134 and 164 each comprise a monitoring portion and a balancing portion, and are connected such that each capacitor is monitored. Each capacitor is also connected such that, based on signals from the monitoring portion of the balancing unit, a heat load 310 can be connected to the capacitor, in order to dissipate excess energy, and to bring down individual capacitor voltage to a predetermined level, which may be 2.50 Volt, depending on type of capacitor used and design goals.

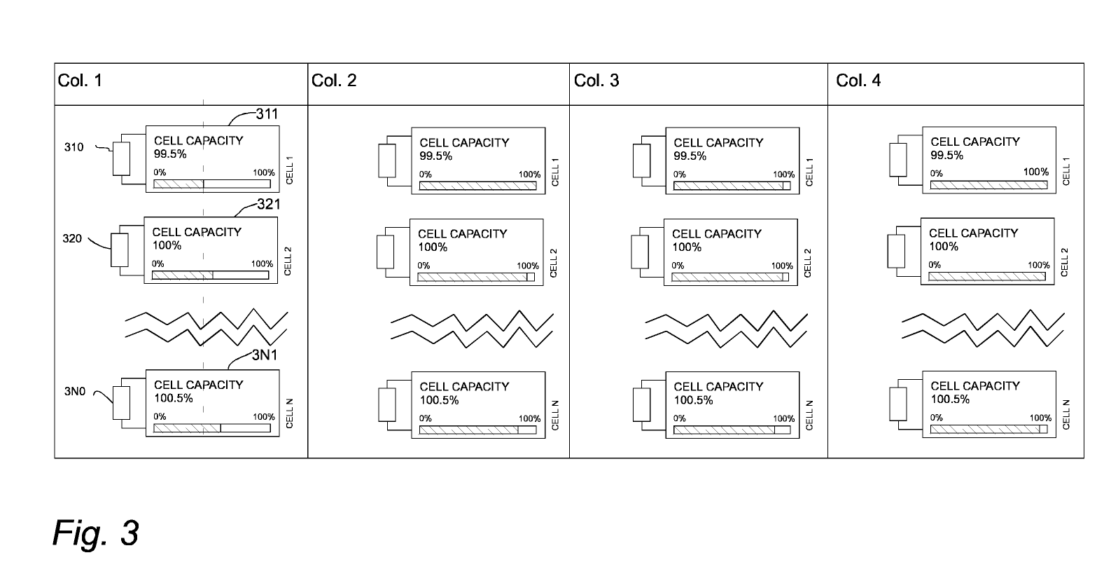

Referring to FIG. 1a and 3, the balancing unit 134 is further described. In FIG. 3 there is illustrated a scenario of balancing a capacitor bank having cells 311, 321, 3N1 comprising individual capacitors of slightly different capacity, and a heat element 310, 320, 3N0 associated to each capacitor.

Note that cell 1, comprises heat element 310 and capacitor together with monitoring and balancing circuitry 311.

Note that cell 1 accommodates less energy than cell 2 and cell N. In column 1 it is illustrated that the cells are discharged after a working period. Because the capacities of the cells deviate from each other, cell 1 is more discharged than the rest. In column 2 it is illustrated that the cells have been charged for a while, and because the capacities of the cells deviate from each other, cell 1 becomes fully charged earlier than the rest of the cells. Cell 1 now connects its heating element and thus transforms energy to heat. Simultaneously the monitoring circuit register this and send signals via an optical communication 138, 160 with the effect to pause the charging. The charge control unit 162 receives these signals and controls the charge regulator 154 to do so.

In column 3 of FIG. 3 it is illustrated that cell 1 now has dissipated a suitable amount of energy. Note that cell 1 and cell 2 have reached the same charge level while cell N has not reached that charge level. The monitoring circuit requests via optical communication 138, 160 that the charging procedure shall be resumed.

In column 4 of FIG. 3 it is illustrated that the cells 1 and 2 now have been further charged. These cells now connect their respective heat element and converts energy to heat. At the same time the monitoring circuits of the balancing unit 134 registers this and signals, via the optic communication units 138, 160 that the charging procedure shall be paused. Because the capacitance of cell N is slightly greater than the capacitance of the other cells, cell N is not fully charged yet, in other words it accommodates, or has the capability to accommodate, more energy than the rest of the cells.

After a few cycles involving charging pauses and heat dissipation, all cells will eventually become fully charged.

Thus, the process of charging the capacitor banks can be worded as follows:
apply a charging voltage;
repeatedly measure the individual voltage of each capacitor;
decide for each capacitor if voltage is higher than a specified threshold voltage;
based on decision, disrupt charging of capacitor bank, and connect those capacitors whose voltage is higher than the threshold to the corresponding heat element;
if no voltage is higher disconnect heat elements and resume/continue charging.

The heat elements 310, 320, 3N0 of the balancing unit 134 preferably comprises one or more standard resistors. The balancing unit also comprises electrically controlled switches which connect the resistors when transformation of energy to heat is required.

The system preferably comprises reinforced PCB conductors to allow for the relatively high currents. Reinforcements may be in the shape of external cupper plates.

### EXAMPLE 1

In an exemplary embodiment the capacitors of the capacitor banks are so called super capacitors or so called ultra-capacitors arranged to have a maximum operational voltage in the interval of 2.50 Volt to 2.55 Volt. In the shuttle, N capacitors are coupled in series to allow for a maximum first capacitor bank 132 voltage of N times 2.50 Volt. In the transfer cart 150, M capacitors are coupled in series to allow for a maximum second capacitor bank 156 voltage of M times 2.50 Volt. The maximum operational voltage of the second capacitor bank 156 is arranged to be higher than the operational voltage of the first capacitor bank 132 to facilitate easy charging of the latter.

The balancing process proceeds as follows. When the charger is signalled that a cell reached 2.55 Volt, the charging ceases and the balancing circuit of the cell starts converting energy to heat until the voltage of the cell has dropped to 2.50 Volt. After that the charging is resumed. The procedure allows all cells to be charged to 2.50 V also when capacitance variations exist between them. This because there is a selective transformation of charge to heat.

### EXAMPLE 2

In a second example the system is devised as follows. For each capacitor bank all capacitors are arranged on a single circuit board, and a monitoring and balancing system is integrated on the same board. The balancing system balances and signals to the charger if any single cell has reached 2.55 V. If this is the case, the charging is paused or halted, and the surplus of the over charged cell is converted to heat as described above. The heat is ventilated away.

### EXAMPLE 3

In automated goods storage facility goods weighing about 750 kg to about 4500 kg are handled. Calculations have shown that with a battery based solution, batteries would weigh 44 kg. A solution according to the invention, based on capacitors would weigh only 3 kg. The capacitor bank of the transfer cart is designed and charged to a voltage of 130 V. The capacitor bank of the shuttle is designed and charged to a voltage of 90 V.

Calculations performed have shown that an amount of energy of 9000 Joule was needed for a procedure of lifting a pallet carrying a 750 kg load, moving it 12 m, and subsequently put it down again. Such a procedure would take about 15 seconds.

Real tests have confirmed the calculations. Super capacitors specified for at least 500 000 complete charging cycles without capacity dropping below 80% are easily acquired. These super capacitors have a lifespan of 10 years. Those capacitors may easily fit the present application with enough design margins. Capacitors may, in contrast to lead accumulators, and lithium accumulators, be transported freely by air when they are discharged, because they are discharged and carry no chemical or electrical energy.

It may be argued that super capacitors are not a good design choice because the voltage is dropping as energy is delivered. For example, a 10 Farad capacitor discharged by 1 V provides 900 Joule at 90 V, but at 60 V, a corresponding 1 V discharge will only provide 600 Joule. The present invention takes care of this by providing control and regulation units that measure the voltage and produces a comparative larger discharge in volts at a lower voltage than at a higher.

Due to relatively large voltage variations that appear in a system according to the invention, motor powers are preferably dimensioned taking into account the lowest voltage allowed in the system. Certain components may additionally require a stable voltage feed, and the system, in such case, is therefore provided with voltage stabilizer to handle that issue.

Most super capacitors handle a maximum of 2.85 Volt per cell. A maximum desired voltage of 90 V with a 10% margin results in 90/2.5 i.e. 36 capacitors (cells). It is advantageous to monitor the cells individually because small variations in capacity may result in that some cells are charged fully before others and may otherwise be over-charged. In the present invention this is handled by a monitoring/balancing system described in another section of this document.

A further aspect is the charging. A working cycle requiring discharge of 10 000 Joule reduces the voltage of a 10 Farad capacitor bank from 90 V to 79 V. This amount of energy is reloaded within a short period of time. Using a charge current of 1 A will reload within 110 seconds. 10 A will reload within 11 seconds. Using 40 A to reload brings time down to 2.75 seconds.

In the present invention a small charger is charging the capacitor bank of the transfer cart. The capacitor bank of the transfer cart is then used to provide the fast charge of the shuttle capacitor bank. Calculations have shown that given 20 seconds for the transfer cart capacitor pack to reload 10 000 Joule, this may be done with a 5 A charger of 450 W. This allows for easy installation because the cable area for the cable to the charger can be held low.

While certain illustrative embodiments of the invention have been described in particularity, it will be understood that various other modifications will be readily apparent to those skilled in the art without departing from the scope of the invention. Accordingly, it is not intended that the scope of the claims appended hereto be limited to the description set forth herein but rather that the claims be construed as encompassing all equivalents of the present invention which are apparent to those skilled in the art to which the invention pertains.

### LEGEND

110 Shuttle

111 Storage aisle

112 Propulsion motor (of shuttle)

113 Transport aisle

114 Lift motor (of shuttle)

115 Shuttle wheel

116 Motor control unit (of shuttle propulsion motor)

117 Transport baseboard

118 Motor control unit (of shuttle lift motor)

120 Regulator (of shuttle)

122 Control unit

124 Radio communications unit

126 Sensor

127 Sensor

128 Sensor

132 First capacitor bank

134 Balancing unit (of first capacitor bank)

136 Charging connector (of shuttle)

138 Optic communication unit (of shuttle)

150 Transfer cart

152 Charging connector (of transfer cart)

154 Charging regulator

156 Second capacitor bank

158 Charger

160 Optic Communication unit

162 Charging control unit

164 Balancing unit (of second capacitor bank)

166 Propulsion motor (of transfer cart)

168 Lift motor (of transfer cart)

170 Motor control unit (of transfer cart propulsion motor)

171 Motor control unit (of transfer cart lift motor)

172 Control unit (of transfer cart)

174 Regulator (of transfer cart)

176 Sliding contact

178 Radio communications unit (of transfer cart)

180 Sensor

182 Sensor

184 Sensor

190 Lifting gear

199 Goods storage

310, 320, 3N0 Heat element

311, 321, 3N0 Capacitor cell

1. A set of transport vehicles for an automated storage facility having a plurality of storage aisles arranged in parallel and one or more transport aisles, perpendicular to, and running along consecutive first ends of a first group of storage aisles on one side of the transport aisle, and optionally having a second group of storage aisles on the other side of the transport aisle, the set of transport vehicles comprising a transfer cart having wheels and being capable of running on rails of the transport aisle, and capable of carrying a shuttle, the shuttle having wheels and being capable of running on rails of the storage aisles and capable of collecting, carrying, and leaving goods stored in the storage aisle,
wherein
the shuttle comprises:
at least one shuttle electric motor,
a first capacitor bank to provide energy to power the at least one shuttle electric motor, and
a shuttle motor control unit to control the at least one motor by controlling electric current energy flow from the first bank of capacitors to the at least one shuttle electric motor,
a first connector organ to electrically connect the shuttle to the transfer cart and in that
the transfer cart comprises:
at least one transfer cart electric motor,
a second connector organ to electrically connect the shuttle to the transfer cart via the first connector organ,
a transfer cart motor control unit to control the at least one transfer cart electric motor, and
a second bank of capacitors to provide energy to charge the shuttle first bank of capacitors, via the connector organs, when the shuttle is carried by, and connected to the transfer cart.

2. The set of vehicles of claim 1, wherein the transfer cart is provided with a sliding contact to pick up energy from an electric feed rail running parallel to the rails of the transport aisle.

3. The set of vehicles according to claim 1 wherein the shuttle is provided with a first balancing unit connected to the first capacitor bank, for monitoring and balancing the first capacitor bank.

4. The set of vehicles according to claims 1 wherein the shuttle is provided with a second balancing unit connected to the second capacitor bank for monitoring and balancing the second capacitor bank.

5. The set of vehicles of claim 4 wherein the shuttle is provided with a first balancing unit connected to the first capacitor bank, for monitoring and balancing the first capacitor bank, wherein the set is provided with optic communications units to exchange information between the balancing unit of the first capacitor bank and the charge control unit of the transfer cart making it possible to pause charging of the first capacitor bank.

6. The set according to claim 5 wherein the balancing includes a step of monitoring the individual capacitors and, based on information gained during monitoring, and
dissipating energy from individual capacitors in order to avoid excess charging.

7. A method of providing power to a set of vehicles according to claim 1, the method comprising:
charging a capacitor bank of the transfer cart from a feed rail via a sliding contact,
connecting the transfer cart to the shuttle with the aid of connector organs
charging a capacitor bank of the shuttle by draining energy from the capacitor bank of the transfer cart.

8. The method of claim 7 further comprising controlling the charging with the aid of a monitoring and balancing procedure including monitoring the voltage of each individual capacitor and dissipating heat based on the monitored voltage.

9. The method of claim 8 further comprising pausing the charging while dissipation is still in progress.

10. The method of claim 9 further comprising communicating, preferably via an optic communications link, from the shuttle to the transfer cart when to pause and when to resume charging.
